(19) United States
(12) Patent Application Publication
(10) Pub. No.: US 2008/0248358 A1
(43) Pub. Date: Oct. 9, 2008

(54) POLYMER ELECTROLYTE FUEL CELL AND PRODUCTION METHOD THEREOF

(75) Inventors: Kazuya Miyazaki, Tokyo (JP); Hiroyuki Tanaka, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/014,242

(22) Filed: Jan. 15, 2008

(30) Foreign Application Priority Data
Jan. 23, 2007 (JP) 2007-013104

(51) Int. Cl. H01M 8/10; H01M 8/00

(52) U.S. Cl. 429/30; 429/41; 29/623.1

(57) ABSTRACT

Provided is a polymer electrolyte fuel cell which can rapidly absorb and diffuse water produced in a porous metal body and allows the water to be transpirated into the atmosphere, thereby enabling a stable operation for a long period of time even at a time of high-humidity/high-current density operation. The polymer electrolyte fuel cell includes a polymer electrolyte membrane; a pair of catalyst layers and a pair of gas diffusion layers, each pair of which is disposed so as to sandwich the polymer electrolyte membrane; and a porous metal body disposed on at least one of the pair of gas diffusion layers, in which boehmite alumina having an arithmetic mean roughness Ra of 5 nm or more and 1 μm or less is provided on at least a part of a surface of the porous metal body.

### BACKGROUND OF THE INVENTION

1. Field of the Invention

The present invention relates to a polymer electrolyte fuel cell (or proton exchange membrane fuel cell) and a production method thereof.

2. Description of the Related Art

A polymer electrolyte fuel cell has high energy conversion efficiency, is clean, and is quiet, thereby being expected as a future energy generation device. Specifically, in recent years, the polymer electrolyte fuel cell receives attention in view of not only application to automotive power generators, residential power generators, or the like, but also possibility of the application to small electrical devices such as mobile phones, notebook personal computers, or digital cameras owing to high energy density of the polymer electrolyte fuel cell. However, in order to put the polymer electrolyte fuel cell for the small electric apparatuses into practical use, there are still unsolved problems such as size reduction of a system as a whole and improvement in power generation efficiency thereof.

In a case where a fuel cell is mounted onto a small electrical device, a battery itself needs to be reduced in size. Accordingly, there is widely adopted a system (air breathing system) of supplying air from an air hole to an air electrode due to natural diffusion without using a pump, a blower, or the like. In a case of adopting a compact, natural aspiration system for a system component of a small fuel cell, in order to realize a higher output of the fuel cell, water control is very important. That is, it is necessary to solve the problem of so-called flooding in which water produced in a cathode catalyst at a time of high-current density operation causes clogging of a catalyst layer, a gas diffusion layer, and pores of a porous metal body or the like to shut off supply of an oxidizer gas. In particular, regarding a cell stack employing a natural aspiration system, in which a porous metal body having no effective water discharging function, condensation of produced water occurs in the porous metal body at a time of high-current density operation in a high-humidity environment, whereby the pores are clogged to make the air intake very unstable.

As a method of solving flooding due to residence of produced water in a porous metal body, there have been proposed various methods. For example, there are a method in which a water absorbing layer formed of a powder-sintered layer is provided to a surface of the porous metal body formed of a foamed metal, thereby absorbing produced water by a capillary action and effectively transpirate the produced water into the air (Japanese Patent Application Laid-Open No. 2004-063096), and a method in which a super-hydrophilic layer is formed on an inner surface of a porous metal body, thereby preventing rapid movement of produced water and clogging of the pores (Japanese Patent Application Laid-Open No. 2006-100155).

However, with the method according to Japanese Patent Application Laid-Open No. 2004-063096, the water absorbing ability of the powder-sintered layer is insufficient, so that the stability at the time of high-humidity/high-current density operation is not sufficient.

Further, also with the method according to Japanese Patent Application Laid-Open No. 2006-100155, of the super-hydrophilic layer having fine unevenness, the desirable range of the size of the unevenness is about 50 nm, which is relatively small, so that the stability at the time of high-humidity/high-current density operation is insufficient. Further, since the super-hydrophilic layer is formed through vacuum evaporation by plasma CVD, it is difficult to form the super-hydrophilic layer uniformly on the inner surface of the porous metal body.

As described above, in the methods according to the background art, countermeasures against flooding in the porous metal body have not had sufficient effects, so that it has been difficult to perform stable power generation for a long period of time in a high-humidity environment.

### SUMMARY OF THE INVENTION

The present invention has been accomplished in view of the above-mentioned background art. It is therefore an object of the present invention to provide a polymer electrolyte fuel cell which can rapidly diffuse water produced in a porous metal body and allows the water to be transpirated into the atmosphere, thereby enabling a stable operation for a long period of time even at a time of high-humidity/high-current density operation.

According to one aspect of the present invention, there is provided a polymer electrolyte fuel cell including: a polymer electrolyte membrane; a pair of catalyst layers and a pair of gas diffusion layers, each pair of which is disposed so as to sandwich the polymer electrolyte membrane; and a porous metal body disposed on at least one of the pair of gas diffusion layers, in which boehmite alumina having an arithmetic mean roughness Ra of 5 nm or more and 1 μm or less is provided on at least a part of a surface of the porous metal body.

In the present invention, it is preferred that the boehmite alumina is not provided at a portion in which the porous metal body and a fuel cell member including the gas diffusion layer are in electrical contact with each other.

Further, it is preferred that the porous metal body includes a foamed metal.

Moreover, it is preferred that the boehmite alumina provided to the porous metal body is formed by applying a hot water treatment to an alumina film formed by using a coating solution which contains an aluminum compound.

According to another aspect of the present invention, there is provided a method of producing a polymer electrolyte fuel cell which includes a polymer electrolyte membrane, a pair of catalyst layers and a pair of gas diffusion layers, each pair of which is disposed so as to sandwich the polymer electrolyte membrane, and a porous metal body disposed on at least one of the gas diffusion layers, the method including: applying a solution containing an aluminum compound to the porous metal body to form an alumina film; and applying a hot water treatment to the alumina film to convert the alumina into boehmite alumina.

In the present invention, it is preferred that the above-mentioned method further includes: prior to the formation of the alumina film by applying the aluminum compound containing solution to the porous metal body, covering a part of a surface of the porous metal body with a resin;

after the formation of the boehmite alumina by applying the hot water treatment to the alumina film, removing the resin; and
assembling a polymer electrolyte fuel cell such that the resin-removed surface and a fuel cell member including the gas diffusion layer are in electrical contact with each other.

Alternatively, in the present invention, it is preferred that the above-mentioned method further includes:

prior to the formation of the alumina film by applying the aluminum compound containing solution to the porous metal body, covering a part of a surface of the porous metal body with gold; and
after the formation of the boehmite alumina by applying the hot water treatment to the alumina film, assembling a polymer electrolyte fuel cell such that the surface covered with gold and a fuel cell member including the gas diffusion layer are in electrical contact with each other.

In the present invention, it is also preferred that the boehmite alumina has an arithmetic mean roughness Ra of 5 nm or more and 1 μm or less.

Further features of the present invention will become apparent from the following description of exemplary embodiments with reference to the attached drawings.

### BRIEF DESCRIPTION OF THE DRAWINGS

FIG. 1 is a schematic cross-sectional view illustrating a part of an example of a single cell unit of a polymer electrolyte fuel cell of the present invention.

FIG. 2 is a schematic view illustrating an inner portion of an example of a porous metal body on which boehmite alumina is formed according to the present invention.

FIG. 3 is a scanning electron microscope (FE-SEM) photograph of boehmite alumina formed on a surface of a skeleton of a porous metal body according to the present invention.

FIG. 4 is a schematic cross-sectional view of an evaluation device for a polymer electrolyte fuel cell.

### DESCRIPTION OF THE EMBODIMENTS

Hereinafter, a detailed description will be made of polymer electrolyte fuel cells (hereinafter, sometimes simply referred to as “fuel cells”) according to preferred embodiments of the present invention. It is to be noted that materials, dimensions, shapes, relative configurations, and the like of components described in the following embodiments are illustrative only and are not intended to be limitative of the invention unless otherwise noted. Similarly, the below-mentioned production method is merely illustrative and, thus, other production methods may also be employed in accordance with the invention.

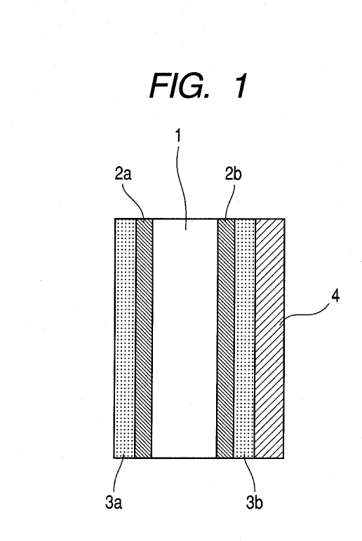

FIG. 1 is a schematic cross-sectional view illustrating a part of an example of a single cell unit of a polymer electrolyte fuel cell of the present invention. In FIG. 1, a polymer electrolyte membrane 1 is sandwiched by a catalyst layer (anode) 2a and another catalyst layer (cathode) 2b, and a gas diffusion layer (anode) 3a and another gas diffusion layer (cathode) 3b. Further, on an outer surface on the air intake side of the cathode-side gas diffusion layer 3b, there is disposed a porous metal body 4 on which boehmite alumina having an arithmetic mean roughness Ra of 5 nm or more and 1 μm or less is formed. Although this embodiment illustrates an example in which the porous metal body is disposed, the arrangement structure of the porous metal body is not limited thereto, and the present invention is intended to also include a case where the porous metal body is disposed on outer surfaces of the gas diffusion layers on the both electrode sides, and various arrangement structures can be selected depending on use or operation conditions of the fuel cell.

The gas diffusion layer is a fuel cell component having functions of gas diffusion, water penetration, moisturization, current collection, and the like. That is, in order to effectively perform the electrode reaction, the gas diffusion layer is formed of a member which is required to uniformly and sufficiently supply a fuel gas or an oxidizer gas to a reaction region of the catalyst, to effectively discharge an excessive reaction product water from the catalyst layer, to prevent drying of the electrolyte membrane, and to enable effective extraction of an electric charge generated by the electrode reaction to the outside of a fuel cell unit. An ordinary gas diffusion layer is formed of two layers, that is, a support layer and a microporous layer so that the above-mentioned functions are satisfied. The support layer is a conductive carbon substrate having a pore size distribution of several hundreds of nanometers or more and several tens of micrometers or less. As the conductive carbon substrate, there can be used carbon cloth, carbon paper, carbon non-woven cloth, or the like, to which a water repellent treatment is applied. Further, the microporous layer is formed of various carbon fine particles and a water repellent agent, and is formed on a support layer so as to have a pore size distribution of several nanometers or more and several hundreds of micrometers or less. The gas diffusion layer is a fuel cell component having the important functions related to power generation performance as described above, so that an optimum member is appropriately selected according to a stack structure and system operation conditions.

The porous metal body is a fuel cell component which uniformly and sufficiently supplies a fuel gas or an oxidizer gas to a surface of a gas diffusion layer and has a current collecting function. For example, a foamed metal is employed therefor. For the foamed metal, there can be used a conductive metal material having a continuous pore structure, which is open to the outside and has a pore size distribution of several tens of microns or more and several millimeters or less and a porosity of 70 percent or more and 99 percent or less, and which also has corrosion resistance and a sufficient mechanical strength.

Unlike the gas diffusion layer, the porous metal body itself does not have a water penetration function. Accordingly, unless the porous metal body has some water discharging unit, the pores are immediately clogged to shut off the gas supply. In view of this, the present invention is characterized in that boehmite alumina having an arithmetic mean roughness Ra of 5 nm or more and 1 μm or less, preferably 10 nm or more and 100 nm or less is provided on at least a part of a surface of the porous metal body. By providing the boehmite alumina, water in a portion covered with the boehmite alumina of the surface of the skeleton of the porous metal body is diffused rapidly, and transpiration of the water into the atmosphere is realized. Incidentally, the term “boehmite alumina” as herein employed is intended to include not only boehmite alumina but also pseudo-boehmite alumina. Further, the expression “(at least) a part of a surface of a porous metal body on which boehmite alumina is provided” is intended to mean “(at least) a part of a surface of a skeleton of a porous metal body”.

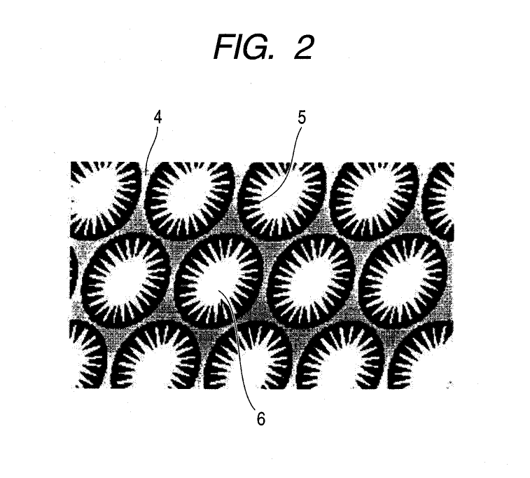

FIG. 2 is a schematic view illustrating an inner portion of an example of a porous metal body on which boehmite alumina is formed according to the present invention. In the figure, boehmite alumina 5 is formed on the surface of the skeleton of a porous metal body 4.

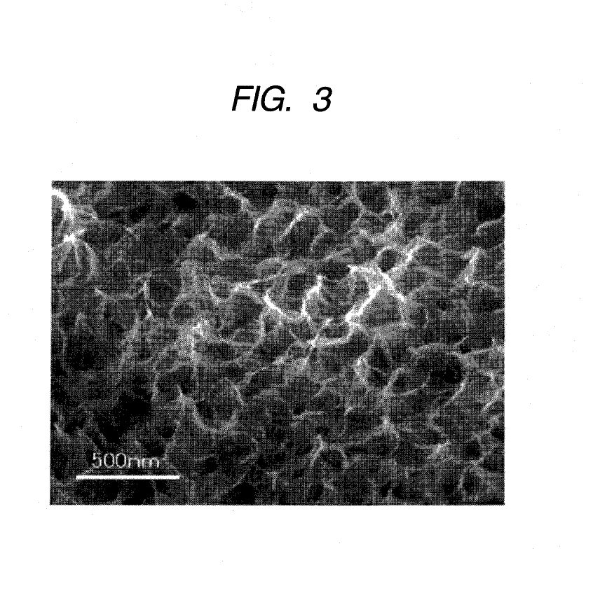

FIG. 3 is a scanning electron microscope (FE-SEM) photograph of boehmite alumina formed on a surface of a skeleton of a porous metal body according to the present invention. The evaluation of the arithmetic mean roughness Ra of fine uneven structure of the boehmite alumina is performed based on numerical values obtained by use of a scanning probe microscope (SPM). The arithmetic mean roughness Ra is determined according to JIS (Japanese Industrial Standards) B 0601-1994 and is defined as follows.

$$Ra = ( 1 / L ) {\int }_{0}^{L} \vert f ( x ) \vert {d}_{x}$$

In the above equation, L represents a reference length and f(x) represents a roughness curve.

The boehmite alumina provided on the surface of the porous metal body is formed by applying a hot water treatment to an alumina film formed by using a coating solution which contains an aluminum compound. For example, the formation can be performed by a method such as dipping.

The boehmite alumina formed by applying the hot water treatment to the alumina film formed by using the coating solution which contains the aluminum compound can be formed uniformly on an inner surface of the porous metal body because various simple liquid-phase formation means can be employed.

Incidentally, in consideration of contact resistance, it is desirable that an electrical contact portion of a surface of the porous metal body with another fuel cell member is not provided with boehmite alumina. Specifically, it is desirable that of the surface of the porous metal body, a portion to be brought into contact with a gas diffusion layer and a portion to be brought into contact with a current collector are not provided with boehmite alumina. As a method of making sure that boehmite alumina is not provided to the above-mentioned portions, there are included, for example, a method in which, prior to the formation of the alumina film using the coating solution which contains the aluminum compound described above, a part of the surface of the porous metal body is covered with a resin, and after the formation of boehmite alumina, the resin is removed prior to assembling of the fuel cell, and a method in which prior to the formation of the alumina film by applying the aluminum compound containing solution, a part of a surface of the porous metal body is covered with gold, and after the formation of the boehmite alumina, a polymer electrolyte fuel cell is assembled such that the surface covered with gold and a fuel cell member including the gas diffusion layer are in electrical contact with each other.

In the case of the latter method, boehmite alumina existing in a portion being in contact with a fuel cell member including the gas diffusion layer is easily peeled off by a clamping pressure at the time of assembling of a fuel cell stack to thereby expose gold at a surface and therefore does not behave as an electrical resistance factor.

The catalyst layer may be formed by directly forming and bonding a slurry which contains platinum-carrying carbon or the like to a polymer electrolyte membrane by a spraying method or a decal method. Alternatively, a catalyst layer formed on a gas diffusion layer may be bonded to an electrolyte membrane by a screen printing method, die coating method, doctor blade, or the like. According to the present invention, this is effective for a membrane-electrode assembly of any structure. Further, as the catalyst, there can be more favorably used a catalyst having a dendrite or nanoflake structure, and formed of a platinum oxide, a composite oxide of a platinum oxide and a metallic element other than platinum, platinum obtained by reducing those, or a multi metal alloy including platinum. The catalyst having the dendrite or nanoflake structure can easily be formed by simple reactive vacuum evaporation such as reactive sputtering or reactive ion plating.

As the polymer electrolyte membrane, a perfluorosulfonic acid polymer having a structure in which to a Teflon (trade name) skeleton, side chains having a sulfonic acid group at an end thereof are bonded can be favorably used. In the perfluorosulfonic acid polymer, the Teflon (trade name) skeleton is not crosslinked, and the skeleton portion forms a crystal through bonding by a Van der Waals force. Further, several sulfonic acid groups are aggregated to constitute a reversed micelle structure, which serves as a conduction channel for protons H⁺.

Incidentally, when protons H⁺ move in the electrolyte membrane to the cathode side, since the protons H⁺ move by using water molecules as a medium, the electrolyte membrane needs to also have a function of retaining water molecules. Therefore, the polymer electrolyte membrane has a function of transmitting protons H⁺ generated on the anode side to the cathode side, a function of preventing passage of an unreacted reaction gas (hydrogen and oxygen), and a predetermined function of retaining water. As long as those conditions are satisfied, any member can be selected to be used.

With the adoption of the above-mentioned fuel cell member and fuel cell structure, the polymer electrolyte fuel cell according to the present invention can be favorably produced.

### EXAMPLES

Hereinafter, with illustration of examples, the present invention is described in more detail.

### Example 1

In this example, a membrane-electrode assembly obtained by spraying a platinum-carrying carbon catalyst to an electrolyte membrane is used, commercially available carbon paper is used for gas diffusion layers, and a porous metal body on which boehmite alumina having an arithmetic mean roughness Ra of 50 nm is formed is applied only to a cathode side.

Hereinafter, production steps for the polymer electrolyte fuel cell according to this example are described in detail.

(Step 1)

First, anode and cathode catalyst layers were directly formed on a polymer electrolyte membrane by a spraying method. That is, platinum-carrying carbon (HiSPEC 4000 (trade name); manufactured by Johnson Matthey), Nafion (trade name; manufactured by DuPont), PTFE (polytetrafluoroethylene), IPA, and water were mixed together to prepare a catalyst slurry, and the catalyst slurry was applied on a Nafion 112 electrolyte membrane by a pulse spray device and was then dried. At this time, a mask suitable for a cell size was used to prepare a membrane-electrode assembly formed of a pair of catalyst layers and an electrolyte membrane.

(Step 2)

Next, a porous metal body having boehmite alumina formed thereon according to the present invention was prepared.

A foamed metal (Celmet #5 (trade name); manufactured by Sumitomo Electric Industries, Ltd.) subjected to washing and pretreatment in advance was dipped in an alumina sol solution having a concentration adjusted to 2 mol % to form a coating, and a heat treatment was performed thereto at 200° C. for one hour. Further, the resultant was immersed in hot water of 100° C. for thirty minutes, and was then dried at 100° C. for 10 minutes, thereby forming boehmite alumina on the entire surface of the porous metal body.

Through measurement by a scanning probe microscope, the arithmetic mean roughness Ra of the boehmite alumina was determined to be about 50 nm.

(Step 3)

A single fuel cell unit was prepared to have a structure in which the membrane-electrode assembly prepared in Step 1 was sandwiched between pieces of carbon paper (LT 1200-N (trade name); produced by E-TEK), serving as gas diffusion layers, and further, on the cathode side, the porous metal body having the boehmite alumina formed thereon, prepared in Step 2, was disposed.

### Example 2

In this example, there was provided only on the cathode side, a porous metal body on which boehmite alumina having an arithmetic mean roughness Ra 100 nm was formed on a portion other than a portion to be brought into contact with a gas diffusion layer and with a current collector plate.

Hereinafter, Step 2 and subsequent steps according to this example are shown, and the production steps are described in detail. Step 1 is the same as that of Example 1.

(Step 2)

A porous metal body having boehmite alumina formed thereon according to the present invention was prepared.

A portion to be brought into electrical contact with a gas diffusion layer and with a current collector plate of a foamed metal (Celmet #5 (trade name); manufactured by Sumitomo Electric Industries, Ltd.) subjected to washing and pretreatment in advance was masked (covered) with a resin, and was then dipped in an alumina sol solution having the same concentration as that in Example 1 to form a coating, and a heat treatment was performed thereto at 200° C. for one hour. Further, a UV/ozone ashing treatment was performed thereto at 120° C. for 30 minutes to completely remove the resin used for the masking. Further, the resultant was immersed in hot water of 100° C. for thirty minutes, and was then dried at 100° C. for 10 minutes, thereby forming boehmite alumina on the entire surface of the porous metal body.

Through measurement by a scanning probe microscope, the arithmetic mean roughness Ra of the boehmite alumina was determined to be about 100 nm.

(Step 3)

A single fuel cell unit was prepared to have a structure in which the membrane-electrode assembly prepared in Step 1 was sandwiched between pieces of carbon paper (LT 1200-N (trade name); produced by E-TEK), serving as gas diffusion layers, and further, on the cathode side, the porous metal body having the boehmite alumina formed thereon, prepared in Step 2, was disposed such that the portion thereof from which the resin was removed was in contact with the gas diffusion layer and the current collector plate.

### Example 3

In this example, there was provided only on the cathode side, a porous metal body on which gold was evaporated at a part including at least a portion to be brought into electrical contact with a gas diffusion layer and with a current collector plate and then boehmite alumina having an arithmetic mean roughness Ra 100 nm was formed.

Hereinafter, Step 2 and subsequent steps according to this example are shown, and the production steps are described in detail. Step 1 is the same as that of Example 1.

(Step 2)

A porous metal body having boehmite alumina formed thereon according to the present invention was prepared.

Gold was evaporated in a thickness of 200 nm in a portion to be brought into electrical contact with a gas diffusion layer and with a current collector plate of a foamed metal (Celmet #5 (trade name); manufactured by Sumitomo Electric Industries, Ltd.) subjected to washing and pretreatment in advance. Subsequently, the foamed metal was dipped in an alumina sol solution having the same concentration as that in Example 1 to form a coating, and a heat treatment was performed thereto at 200° C. for one hour. Further, the resultant was immersed in hot water of 100° C. for thirty minutes, and was then dried at 100° C. for 10 minutes, thereby forming boehmite alumina on the entire surface of the porous metal body.

Through measurement by a scanning probe microscope, the arithmetic mean roughness Ra of the boehmite alumina was determined to be about 100 nm.

(Step 3)

A single fuel cell unit was prepared to have a structure in which the membrane-electrode assembly prepared in Step 1 was sandwiched between pieces of carbon paper (LT 1200-N (trade name); produced by E-TEK), serving as gas diffusion layers, and further, on the cathode side, the porous metal body having the boehmite alumina formed thereon, prepared in Step 2, was disposed so as to be in contact with the gas diffusion layer and the current collector plate.

### Comparative Example 1

In this comparative example, the boehmite formation treatment by hot water performed in Step 2 of Example 1 was omitted. That is, alumina in a form of a fine particulate film was formed on the entire surface of a porous metal body.

Hereinafter, Step 2 and subsequent steps according to this comparative example are shown, and the production steps are described in detail. Step 1 is the same as that of Example 1.

(Step 2)

Next, a porous metal body having an alumina fine particulate film formed thereon was prepared.

A foamed metal (Celmet #5 (trade name); manufactured by Sumitomo Electric Industries, Ltd.) subjected to washing and pretreatment in advance was dipped in an alumina sol solution having the same concentration as that in Example 1 to form a coating, and a heat treatment was performed thereto at 200° C. for one hour to thereby form the alumina fine particulate film.

Through measurement by a scanning probe microscope, the arithmetic mean roughness Ra of the alumina fine particulate film was determined to be about 2 nm.

### (Step 3)

A single fuel cell unit was prepared to have a structure in which the membrane-electrode assembly prepared in Step 1 was sandwiched between pieces of carbon paper (LT 1200-N (trade name); produced by E-TEK), serving as gas diffusion layers, and further, on the cathode side, the porous metal body having the alumina fine particulate film formed thereon, prepared in Step 2, was disposed.

### Comparative Example 2

In this comparative example, the porous metal body was not subjected to a surface treatment.

Hereinafter, Step 2 according to this comparative example is shown, and the production step is described in detail. Step 1 is the same as that of Example 1.

(Step 2)

A single fuel cell unit was prepared to have a structure in which the membrane-electrode assembly prepared in Step 1 was sandwiched between pieces of carbon paper (LT 1200-N (trade name); produced by E-TEK), serving as gas diffusion layers, and further, on the cathode side, the porous metal body not subjected to a surface treatment was disposed.

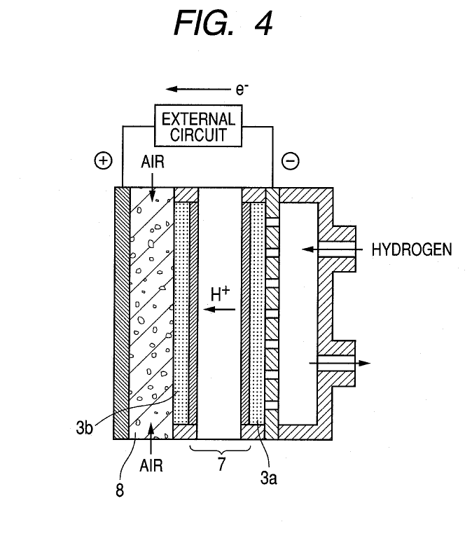

For each of the single fuel cell units produced in the examples and the comparative examples, characteristic evaluation was performed by using an evaluation device structured as illustrated in FIG. 4. In a state where hydrogen gas was supplied to the anode electrode and the cathode electrode was opened to the atmosphere, a constant current test was performed at 400 mA/cm². The results thereof are shown in Table 1 below. In the table, the numerical value of the voltage after long time operation means a voltage value (V) after operation for 5,000 seconds.

TABLE 1

| | | | Voltage after | |
|---|---|---|---|---|
| | | Initial | long time | Voltage |
| | | voltage | operation | drop |
| | | [V] | [V] | [V] |
| Ex. 1 | 25° C. 90% RH | 0.68 | 0.39 | 0.29 |
| | 25° C. 50% RH | 0.65 | 0.45 | 0.20 |
| | 50° C. 30% RH | 0.63 | 0.56 | 0.07 |
| Ex. 2 | 25° C. 90% RH | 0.66 | output~0 | 0.66 |
| | | | after | |
| | | | about 5000 seconds | |
| | 25° C. 50% RH | 0.63 | 0.48 | 0.15 |
| | 50° C. 30% RH | 0.60 | 0.57 | 0.03 |
| Ex. 3 | 25° C. 90% RH | 0.72 | 0.42 | 0.30 |
| | 25° C. 50% RH | 0.71 | 0.66 | 0.05 |
| | 50° C. 30% RH | 0.72 | 0.69 | 0.03 |
| Comp. | 25° C. 90% RH | 0.67 | output~0 | 0.67 |
| Ex. 1 | | | after | |
| | | | about 4000 seconds | |
| | 25° C. 50% RH | 0.64 | output~0 | 0.64 |
| | | | after | |
| | | | about 5000 seconds | |
| | 50° C. 30% RH | 0.62 | 0.58 | 0.04 |
| Comp. | 25° C. 90% RH | 0.67 | output~0 | 0.67 |
| Ex. 2 | | | after | |
| | | | about 2000 seconds | |
| | 25° C. 50% RH | 0.64 | output~0 | 0.64 |
| | | | after | |
| | | | about 4000 seconds | |
| | 50° C. 30% RH | 0.62 | 0.58 | 0.04 |

It has been confirmed from the above results that single fuel cell unit stacks having a structure in which a porous metal body on which boehmite alumina having an arithmetic mean roughness Ra of 5 nm or more and 1 μm or less according to Examples 1, 2, and 3 were able to stably perform power generation for a long period of time especially in a high-humidity environment.

According to the preferred embodiments of the present invention, a polymer electrolyte fuel cell (particularly, of a natural aspiration system) is provided which can rapidly absorb and diffuse water produced in a porous metal body and allows the water to be transpirated into the atmosphere, thereby enabling a stable operation for a long period of time even at a time of high-humidity/high-current density operation, and also can realize significant increase in power generation performance compared to the fuel cells according to the background art.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-013104, filed Jan. 23, 2007, which is hereby incorporated by reference herein in its entirety.

What is claimed is:

1. A polymer electrolyte fuel cell comprising:
a polymer electrolyte membrane;
a pair of catalyst layers and a pair of gas diffusion layers, each pair of which is disposed so as to sandwich the polymer electrolyte membrane; and
a porous metal body disposed on at least one of the pair of gas diffusion layers,
wherein boehmite alumina having an arithmetic mean roughness Ra of 5 nm or more and 1 μm or less is provided on at least a part of a surface of the porous metal body.

2. The polymer electrolyte fuel cell according to claim 1, wherein the boehmite alumina is not provided at a portion in which the porous metal body and a fuel cell member including the gas diffusion layer are in electrical contact with each other.

3. The polymer electrolyte fuel cell according to claim 1, wherein the porous metal body comprises a foamed metal.

4. A method of producing a polymer electrolyte fuel cell which includes a polymer electrolyte membrane, a pair of catalyst layers and a pair of gas diffusion layers, each pair of which is disposed so as to sandwich the polymer electrolyte membrane, and a porous metal body disposed on at least one of the gas diffusion layers, the method comprising:
applying a solution containing an aluminum compound to the porous metal body to form an alumina film; and
applying a hot water treatment to the alumina film to convert the alumina into boehmite alumina.

5. The method according to claim 4, further comprising:
prior to the formation of the alumina film by applying the aluminum compound containing solution to the porous metal body, covering a part of a surface of the porous metal body with a resin;
after the formation of the boehmite alumina by applying the hot water treatment to the alumina film, removing the resin; and
assembling a polymer electrolyte fuel cell such that the resin-removed surface and a fuel cell member including the gas diffusion layer are in electrical contact with each other.

6. The method according to claim 4, further comprising:
prior to the formation of the alumina film by applying the aluminum compound containing solution to the porous metal body, covering a part of a surface of the porous metal body with gold; and
after the formation of the boehmite alumina by applying the hot water treatment to the alumina film, assembling a polymer electrolyte fuel cell such that the surface covered with gold and a fuel cell member including the gas diffusion layer are in electrical contact with each other.

7. The method according to claim 4, wherein the boehmite alumina has an arithmetic mean roughness Ra of 5 nm or more and 1 μm or less.
